(19) United States
(12) Patent Application Publication
(10) Pub. No.: US 2026/0246008 A1
(43) Pub. Date: Aug. 20, 2026

(54) BATTERY CELL COMPRISING COVER INCLUDING COOLING PASSAGE, AND BATTERY DEVICE COMPRISING SAME

(71) Applicant: SK ON CO., LTD., Seoul (KR)

(72) Inventor: Yea-Eun KIM, Daejeon (KR)

(21) Appl. No.: 19/162,406

(22) PCT Filed: Apr. 19, 2024
(86) PCT No.: PCT/KR2024/005342

§ 371 Date: Sep. 5, 2025

(30) Foreign Application Priority Data
Jun. 13, 2023 (KR) 10-2023-0075611

(51) Int. Cl. H01M 10/647; H01M 10/0525; H01M 10/34; H01M 10/613; H01M 10/6561; H01M 50/103; H01M 50/15; H01M 50/209

(52) U.S. Cl. CPC H01M 10/647; H01M 10/0525; H01M 10/345; H01M 10/613; H01M 10/6561; H01M 50/103; H01M 50/15; H01M 50/209

(57) ABSTRACT

Provided is a battery cell comprising: an electrode assembly; a case accommodating the electrode assembly; and a cover surrounding at least a part of the case and including a cooling passage. The cover comprises first surfaces including recesses and second surfaces spaced apart from the first surfaces and including protrusions. At least a part of the case is positioned between the first surfaces and the second surfaces.

### TECHNICAL FIELD

The present disclosure relates to a battery cell including a cover including a cooling passage and a battery device including the same.

### BACKGROUND ART

Unlike primary batteries, secondary batteries may be charged with and discharged of electricity, and thus, may be applied to devices within various fields, such as digital cameras, mobile phones, laptops, hybrid vehicles, electric vehicles, and energy storage systems (ESS). Secondary batteries may be a lithium-ion battery, a nickel-cadmium battery, a nickel-metal hydride battery, or a nickel-hydrogen battery.

Secondary batteries are manufactured as flexible pouch-type battery cells or rigid prismatic or cylindrical can-type battery cells. A plurality of battery cells may be formed as a cell assembly in a stacked form.

The cell assembly may be disposed inside a module housing to form a battery module, and a plurality of battery modules may be arranged inside a pack housing to form a battery pack.

### DISCLOSURE OF INVENTION

### Technical Problem

In a battery for an electric vehicle, heat may be generated due to high output, high speed, and repeated charging. For example, a thermal runaway phenomenon may occur in adjacent battery cells. A battery device (e.g., a battery module or a battery pack) may include components for cooling the battery cells. When a plurality of battery cells are in contact with each other, thermal conductivity may increase and the possibility of thermal runaway may increase.

An aspect of the present disclosure is to provide a battery cell including a cover capable of maintaining an appropriate temperature of a battery cell and preventing thermal transfer and thermal runaway. For example, the cover may cool the battery cell using a cooling passage through which a refrigerant flows.

Another aspect of the present disclosure is to provide a battery cell including a cover capable of improving convenience of assembly.

The battery cell including a cover including a cooling passage of the present disclosure and the battery device including the same may be widely applied in green technology fields, such as electric vehicles, battery charging stations, and other solar power generation and wind power generation using batteries. In addition, the battery cell including a cover including a cooling passage of the present disclosure and the battery device including the same may be used in eco-friendly electric vehicles, hybrid vehicles, etc. to prevent climate change by suppressing air pollution and greenhouse gas emissions.

### Solution to Problem

According to an aspect of the present disclosure, a battery cell may include an electrode assembly, a case accommodating the electrode assembly, and a cover surrounding at least a portion of the case and including a cooling passage. The cover may include a first surface, including a groove, and a second surface spaced apart from the first surface and including a protrusion. At least a portion of the case may be located between the first surface and the second surface.

According to an embodiment, the case may include a bottom surface, a first side surface extending from the bottom surface, and a second side surface extending from the bottom surface and spaced apart from the first side surface. The cover may include a base cover and a side cover connected to the base cover and including a first side cover covering the first side surface and a second side cover covering the second side surface.

According to an embodiment, the cooling passage may include an inlet formed in the first side cover, a connection passage formed in the base cover and connected to the inlet, and an outlet formed in the second side cover and connected to the connection passage.

According to an embodiment, the side cover may include a first end portion having a first width and facing the base cover and a second end portion, opposite to the first end portion, having a second width less than the first width.

According to an embodiment, the second end portion may include a curved portion. A flow rate of a refrigerant passing through the cooling passage located at the second end portion may be faster than a flow rate of a refrigerant passing through the cooling passage located at the first end portion.

According to an embodiment, the case may include a third side surface located between the first side surface and the second side surface and a fourth side surface located between the first side surface and the second side surface and spaced apart from the third side. The side cover may include a first extension forming the first side surface and covering at least a portion of the third side surface and a second extension forming the second side surface and covering at least a portion of the fourth side surface.

According to an embodiment, the electrode assembly and the case are located between the first side cover and the second side cover.

According to an embodiment, the battery cell may further include a sealing member disposed on the side cover and surrounding at least a portion of the cooling passage.

According to an embodiment, the base cover and the side cover may be formed integrally.

According to an embodiment, the first surface may face in a first direction, and the second surface may face in a second direction, opposite to the first direction.

According to an aspect of the present disclosure, a battery device may include a plurality of battery cells and a frame accommodating the plurality of battery cells. Each of the plurality of battery cells may include an electrode assembly, a case accommodating the electrode assembly, and a cover surrounding at least a portion of the case and including a cooling passage. The cover may include a first surface, including a groove, and a second surface spaced apart from the first surface and including a protrusion. At least a portion of the case may be located between the first surface and the second surface.

According to an embodiment, the plurality of battery cells may be coupled to each other using the cover in which the groove and the protrusion may be formed.

According to an embodiment, the cases of the plurality of battery cells may be spaced apart from each other.

### ADVANTAGEOUS EFFECTS OF INVENTION

According to an embodiment of the present disclosure, the cooling efficiency of the battery cell may be increased and thermal runaway may be prevented.

According to an embodiment of the present disclosure, the convenience of assembly of a plurality of battery cells may be improved.

### BRIEF DESCRIPTION OF DRAWINGS

FIG. 1 is a perspective view of a battery cell, according to an embodiment.

FIG. 2 is a top view of a battery cell, according to an embodiment.

FIG. 3a illustrates a first extension including a first surface of a cover, according to an embodiment. FIG. 3b illustrates a second extension including a second surface of a cover, according to an embodiment.

FIGS. 4a and 4b are schematic diagrams illustrating a structure of a cooling passage, according to an embodiment.

FIGS. 5a, 5b, and 5c are perspective views of a side cover, according to an embodiment.

FIG. 6 is a schematic diagram of a battery cell including a sealing structure, according to an embodiment.

FIG. 7 is a top view of a battery device, according to an embodiment.

### BEST MODE FOR THE INVENTION

The present disclosure will be described in detail with reference to the accompanying drawings. However, this is merely illustrative and the present disclosure is not limited to the specific embodiments described by way of example.

Terms and words used in the present specification and claims to be described below should not be construed as limited to ordinary or dictionary terms, and should be construed in accordance with the technical idea of the present disclosure based on the principle that the inventors may properly define their own inventions in terms of terms in order to best explain the invention.

Therefore, the embodiments described in the present specification and the configurations illustrated in the drawings are merely the most preferred embodiments of the present disclosure and are not intended to represent all of the technical ideas of the present disclosure, and thus should be understood that various equivalents and modifications may be substituted at the time of the present application.

Hereinafter, embodiments of the present disclosure will be described in detail with reference to the accompanying drawings. In this case, in the drawings, the same components are denoted by the same reference symbols as possible. Further, the detailed description of well-known functions and constructions which may obscure the gist of the present disclosure will be omitted. Some of the elements in the accompanying drawings are exaggerated, omitted, or schematically illustrated, and the size of each element does not entirely reflect the actual size.

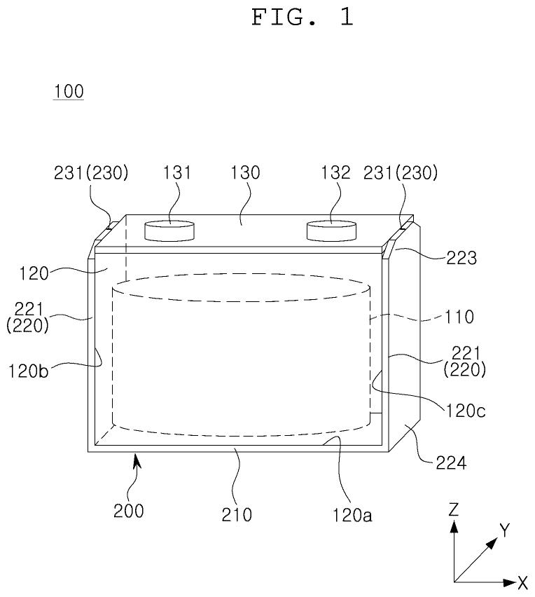

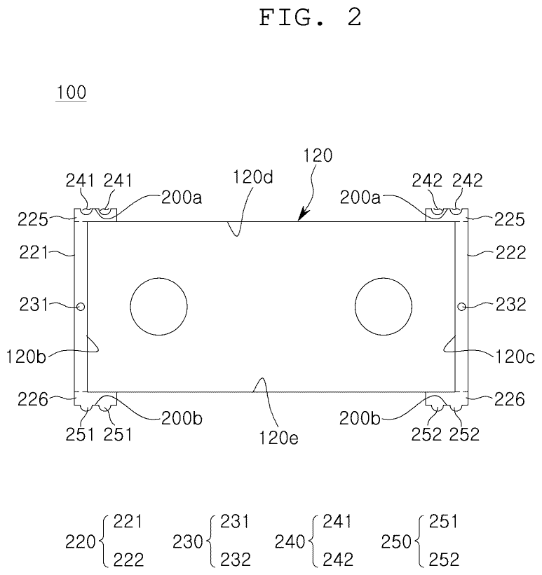

FIG. 1 is a perspective view of a battery cell according to an embodiment. FIG. 2 is a top view of a battery cell according to an embodiment.

Referring to FIG. 1 and/or FIG. 2, a battery cell 100 may include an electrode assembly 110, a case 120, and a cover 200.

According to an embodiment, the battery cell 100 may be a prismatic secondary battery cell. For example, the battery cell 100 may be a lithium ion battery or a nickel metal hydride battery that may be charged with and discharged of electricity.

According to an embodiment, the electrode assembly 110 may include components for charging and/or discharging. For example, the electrode assembly 110 may include at least one positive electrode plate, at least one negative electrode plate, and at least one separator. The electrode assembly 110 may be accommodated in the case 120.

The structure of the electrode assembly 110 may be optionally designed. For example, the electrode assembly 110 may be a wound jelly roll-type assembly, a Z-folding-type assembly including a multi-folded separator, or a stack-type assembly.

The case 120 may form at least a portion of an outer surface of the battery cell 100 and accommodate the electrode assembly 110. For example, the case 120 may provide a space in which the electrode assembly 110 and an electrolyte (not shown) are accommodated. According to an embodiment, the case 120 may include aluminum. The case 120 may be referred to as a can or a housing.

The case 120 may have a substantially rectangular prism shape with at least a portion of the case open. For example, the case 120 may include a bottom surface 120a, a first side surface 120b, a second side surface 120c opposite to the first side surface 120b, a third side surface 120d located between the first side surface 120b and the second side surface 120c, and a fourth side surface 120e located between the first side surface 120b and the second side surface 120c and opposite to the third side surface 120d. The second side surface 120c may be spaced apart from the first side surface 120b. The fourth side surface 120e may be spaced apart from the third side surface 120d.

The side surfaces 120a, 120b, 120c, and 120d may be substantially perpendicular to the bottom surface 120a. The bottom surface 120a may face in a direction opposite to a cap assembly 130. Widths of the first side surface 120b and the second side surface 120c may be narrower than widths of the third side surface 120d and the fourth side surface 120e. In an embodiment, the first side surface 120b and the second side surface 120c may be referred to as a first narrow side surface and a second narrow side surface, respectively, and the third side surface 120d and the fourth side surface 120e may be referred to as a first wide side surface and a second wide side surface, respectively.

According to an embodiment, the battery cell 100 may include the cap assembly 130. The cap assembly 130 may be combined with the case 120 to form a receiving space for receiving the electrode assembly 110 and the electrolyte.

The cap assembly 130 may include a positive electrode terminal 131 and a negative electrode terminal 132. The positive electrode terminal 131 and the negative electrode terminal 132 may be electrically connected to a positive electrode plate and a negative electrode plate of the electrode assembly 110, respectively. According to an embodiment, the cap assembly 130 may include components (e.g., a venting portion, an electrolyte injection port) (not shown) used for the function of the battery cell 100.

According to an embodiment, the cover 200 may surround at least a portion of the case 120. For example, the cover 200 may include a base cover 210 covering a bottom surface 120a of the case 120 and a side cover 220 covering at least a portion of the side surfaces 120b, 120c, 120d, and 120e.

The side cover 220 may include a first side cover 221 connected to one end portion of the base cover 210 and covering the first side surface 120b and a second side cover 222 connected to the other end portion of the base cover 210 and covering the second side surface 120c. According to an embodiment, the electrode assembly 110 and the case 120 may be located between the first side cover 221 and the second side cover 222. For example, the case 120 may be inserted and assembled between the first side cover 221 and the second side cover 220.

According to an embodiment, the base cover 210 and the side cover 220 may be formed integrally. According to an embodiment, the side cover 220 may include a first end portion 223 connected to the base cover 210 and a second end portion 224 opposite to the first end portion 223.

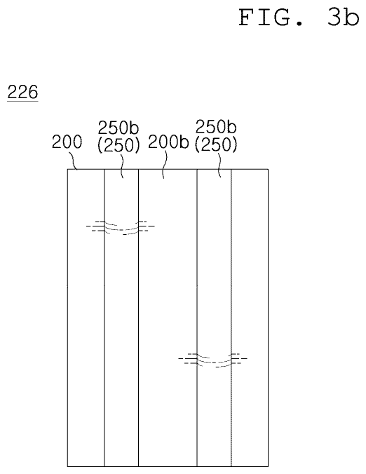

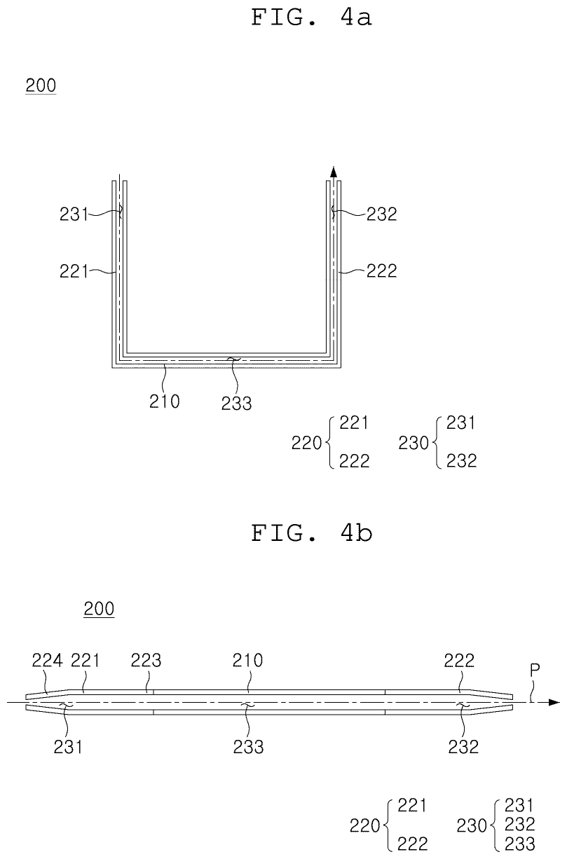

According to an embodiment, the cover 200 may include a cooling passage 230 for cooling the battery cell 100. The cooling passage 230 may provide a path for a refrigerant (e.g., air or coolant) to flow. According to an embodiment, the cooling passage 230 may include an inlet 231 formed in the first side cover 221 and an outlet 232 formed in the second side cover 222. The inlet 231 and the outlet 232 may be connected using a connection passage (e.g., a connection passage 233 of FIG. 4a) formed in the base cover 210. For example, the refrigerant transferred to the inlet 231 may pass through the inlet 231 and the connection passage 233 so as to be discharged to the outlet 232.

At least a portion of heat generated in the electrode assembly 110 may be transferred to the case 120. Since the cover 200 surrounds at least a portion of the case 120, heat from the battery cell 100 may be dispersed. For example, the battery cell 100 may be cooled by the cooling passage 230 of the cover 200. The amount of heat transferred to the surface (e.g., in a Z-X plane direction) of the battery cell 100 may be greater than the amount of heat transferred in a stacking direction (e.g., in a Y-axis direction) of the battery cell 100. Since the cover 200 surrounds the bottom surface 120a, the first side surface 120b, and the second side surface 120c of the case 120, the heat dissipation effect of the cover 200 may be improved.

According to an embodiment, the cover 200 of one battery cell 100 may have a structure for coupling to the cover 200 of another battery cell 100. For example, the cover 200 may include a groove 240 and a protrusion 250.

According to an embodiment, the groove 240 and the protrusion 250 may be formed in the side cover 220. For example, the groove 240 may be formed in a first surface 200a of the side cover 220, and the protrusion 250 may be formed in a second surface 200b of the side cover 220. The second surface 200b may be located opposite to the first surface 200a. For example, a first direction in which the first surface 200a faces may be opposite to a second direction in which the second surface 200b faces, and the first surface 200a and the second surface 200b may be spaced apart from each other. According to an embodiment, at least a portion of the case 120 may be located between the first surface 200a and the second surface 200b.

According to an embodiment, the protrusion 250 of one battery cell 100 may be inserted into the groove 240 of another battery cell 100. The groove 240 and the protrusion 250 may be formed in the cover 200 so as to face each other when a plurality of battery cells 100 are aligned. For example, the groove 240 may include at least one first groove 241 formed in the first surface 200a of the first side cover 221 and at least one second groove 242 formed in the first surface 200a of the second side cover 222. The protrusion 250 may include at least one first protrusion 251 formed on the second surface 200b of the first side cover 221 and at least one second protrusion 252 formed on the second surface 200b of the second side cover 222.

According to an embodiment, the side cover 220 may cover at least a portion of the wide surface (e.g., the third side surface 120d and the fourth side surface 120e) of the case 120. For example, the side cover 220 may include a first extension 225 covering at least a portion of the third side surface 120d and a second extension 226 covering at least a portion of the fourth side surface 120e. The first extension 225 may form the first surface 200a. The second extension 226 may form the second surface 200b. For example, the first surface 200a may refer to an outer surface of the first extension 225. The second surface 200b may refer to an outer surface of the second extension 226. According to an embodiment, the first extension 225 may include the groove 240. The second extension 226 may include the protrusion 250.

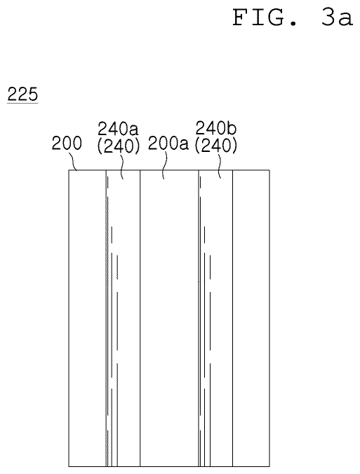

FIG. 3a illustrates a first extension including a first surface of a cover according to an embodiment. FIG. 3b illustrates a second extension including a second surface of a cover according to an embodiment.

Referring to FIGS. 3a and 3b, the cover 200 may include the first extension 225 having the groove 240 formed therein and the second extension 226 having the protrusion 250 formed therein. The description of the cover 200, the extensions 225 and 226, the groove 240, and/or the protrusion 250 of FIG. 1 and/or FIG. 2 may be applied to FIGS. 3a and 3b.

According to an embodiment, the extensions 225 and 226 may have a structure for coupling to another battery cell 100. For example, the first extension 225 of one battery cell 100 may face the second extension 226 of the other battery cell 100. The groove 240 of the first extension 225 may accommodate the protrusion 250 of the second extension 226.

When the protrusion 250 is inserted into the groove 240, a plurality of battery cells 100 may be assembled. By assembling using the groove 240 and the protrusion 250 of the cover 200, the convenience of assembly the battery cell 100 may be improved and a separate adhesive material may not be required. According to an embodiment, by assembling using the groove 240 and the protrusion 250 of the cover 200, bonding force of the plurality of battery cells 100 may be improved.

According to an embodiment, the groove 240 may be a linear empty space formed on the first surface 200a. The protrusion 250 may be a portion of the cover 200 linearly protruding from the second surface 200b.

According to an embodiment, the structure (shape and/or number) of the groove 240 and/or the protrusion 250 may be selectively changed. According to an embodiment, the first extension 225 may include a plurality of grooves 240. For example, the groove 240 may include a first groove 240a and a second groove 240b spaced apart from the first groove 240a. According to an embodiment, the second extension 226 may include a plurality of protrusions 250. For example, the protrusions 250 may include a first protrusion 250a and a second protrusion 250b spaced apart from the first protrusion 250a.

FIGS. 4a and 4b are schematic diagrams illustrating a structure of a cooling passage according to an embodiment. For example, FIG. 4a is a side cross-sectional view of the cover 200. FIG. 4b is a top cross-sectional view of the cover in an unfolded state. For convenience of description, the cover 200 of FIG. 4b is illustrated in an unfolded state. However, those skilled in the art will understand that the side cover 220 of FIG. 4b is formed substantially perpendicular to the base cover 210.

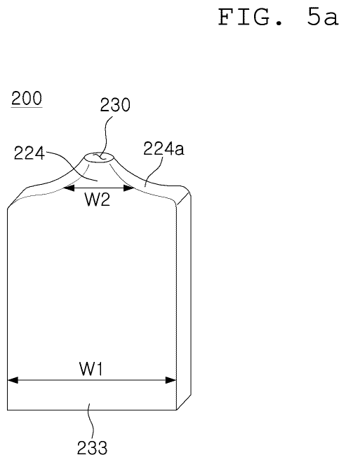

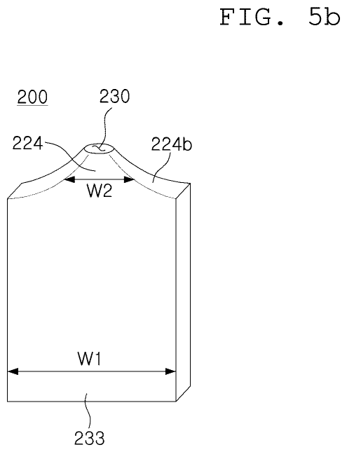

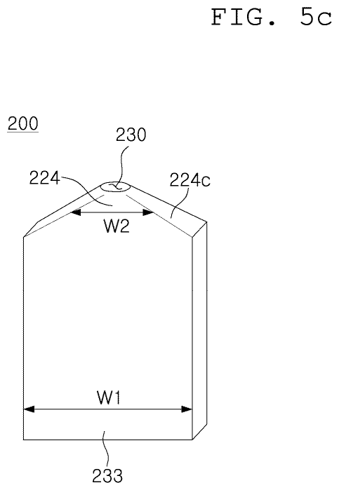

FIGS. 5a, 5b, and 5c are perspective views of a side cover according to an embodiment. For example, FIGS. 5a, 5b, and 5c are perspective views of a portion (e.g., the first side cover 221 or the second side cover 222) of the cover 200.

Referring to FIGS. 4a, 4b, 5a, 5b, and/or 5c, the cover 200 (e.g., the side cover 220) may form the cooling passage 230. The description of the configuration of the base cover 210, the side cover 220, and/or the cooling passage 230 of FIG. 1 and/or FIG. 2 may be applied to the base cover 210, the side cover 220, and/or the cooling passage 230 of FIGS. 4a, 4b, 5a, 5b, and/or 5c.

The side cover 220 may include the cooling passage 230. The cooling passage 230 may include the inlet 231 and the outlet 232 formed in the side cover 220. The cooling passage 230 may include a connection passage 233 formed in the base cover 210. The side cover 220 may include a first end portion 223 connected to the base cover 210 and a second end portion 224 opposite to the first end portion 223. The inlet 231 and the outlet 232 of the cooling passage 230 may be formed in the second end portion 224. For example, the inlet 231 may be formed in the second end portion 224 of the first side cover 221, and the outlet 232 may be formed in the second end portion 224 of the second side cover 222. The inlet 231 may be connected to one end portion of the connection passage 233. The outlet 232 may be connected to the other end portion of the connection passage 233.

According to an embodiment, the side cover 220 may have a structure for improving a flow rate of a refrigerant passing through the cooling passage 230. A first width W1 of the first end portion 223 may be substantially the same as a width of the base cover 210. A second width W2 of the second end portion 224 may be narrower than the first width W1 of the first end portion 223. A cross-sectional area of the cooling passage 230 may be changed to correspond to the shape of the side cover 220. For example, a cross-sectional area of a portion (e.g., the inlet 231 and the outlet 232) of the cooling passage 230 formed by the second end portion 224 may be less than a cross-sectional area of the cooling passage 230 or the connection passage 233 formed by the first end portion 223.

The cross-sectional area of the inlet 231 and the cross-sectional area of the outlet 232 may each be less than the cross-sectional area of the connection passage 233. Due to the shape of the cooling passage 230, the flow rate of the refrigerant in the inlet 231 and the outlet 232 may be faster than the flow rate of the refrigerant in the connection passage 233. As the flow rate of the refrigerant increases in the inlet 231 and the outlet 232, the heat dissipation effect of the battery cell 100 may be improved. For example, a path P through which the refrigerant flows may be formed in the length direction (e.g., the Z-axis direction of FIG. 1) of the battery cell 100, and heat transfer in the length direction may be improved. Due to the shape of the cooling passage 230, the flow of the refrigerant may be improved. For example, turbulence in the second end portion 224 may be reduced.

According to an embodiment, the first end portion 223 may face an electrode assembly (e.g., the electrode assembly 110 of FIG. 1), and the second end portion 224 may face a cap assembly (e.g., the cap assembly 130 of FIG. 1).

According to an embodiment, the shape of the second end portion 224 of the side cover 220 may be selectively designed. For example, in the case of a structure that may improve the flow rate of the refrigerant in the cooling passage 230 (e.g., the inlet 231 or the outlet 232) located in the second end portion 224, the shape of the second end portion 224 is not limited. According to an embodiment, a cross-sectional area of the cooling passage 230 formed inside the second end portion 224 may have a shape that gradually decreases. The flow rate of the refrigerant passing through the cooling passage 230 located at the second end portion 224 may be faster than the flow rate of the refrigerant passing through the cooling passage 230 located at the first end portion 223.

According to an embodiment (e.g., FIG. 5a and/or FIG. 5b), the second end portion 224 of the cover 200 may include curved portions 224a and 224b. For example, the number of inflection points of the curved portions 224a and 224b of the cooling passage 230 may change depending on the cooling of the battery cell 100.

According to an embodiment (e.g., FIG. 5c), the second end portion 224 of the cover 200 may be formed so that a cross-sectional area thereof is continuously reduced. For example, the second end portion 224 may include an inclined plane 224c.

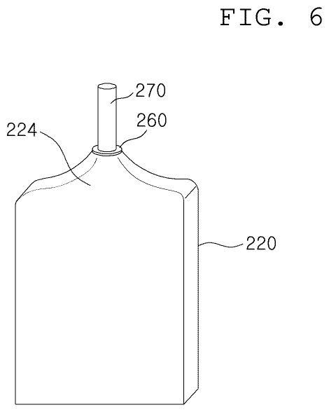

FIG. 6 is a perspective view of a battery cell including a sealing structure according to an embodiment.

Referring to FIG. 6, the battery cell 100 may include a sealing member 260 disposed on the side cover 220. The description of the battery cell 100 and the side cover 220 of FIG. 1 and/or FIG. 2 may be applied to the battery cell 100 and the side cover 220 of FIG. 6.

According to an embodiment, the sealing member 260 may prevent the leakage of refrigerant from a cooling passage (e.g., the cooling passage 230 of FIG. 1) or prevent the introduction of foreign matter into the cooling passage 230. For example, the sealing member 260 may surround at least a portion of the cooling passage (e.g., the cooling passage 230 of FIG. 1). For example, the sealing member 260 may be disposed to be adjacent to an inlet (e.g., the inlet 231 of FIG. 1) or an outlet (e.g., the outlet 232 of FIG. 1). According to an embodiment, the sealing member 260 may be an O-ring.

According to an embodiment, the battery cell 100 may be supplied with a refrigerant (e.g., a coolant) using a refrigerant pipe 270. For example, the refrigerant transferred from the refrigerant pipe 270 may flow inside a cover (e.g., the cover 200 of FIG. 1) to cool the battery cell 100. The refrigerant pipe 270 may be connected to an inlet (e.g., the inlet 231 of FIG. 1) of a first side cover (e.g., the first side cover 221 of FIG. 1) and an outlet (e.g., the outlet 232 of FIG. 1) of a second side cover (e.g., the second side cover 222 of FIG. 1). At least a portion of the sealing member 260 may be located between the refrigerant pipe 270 and the side cover 220.

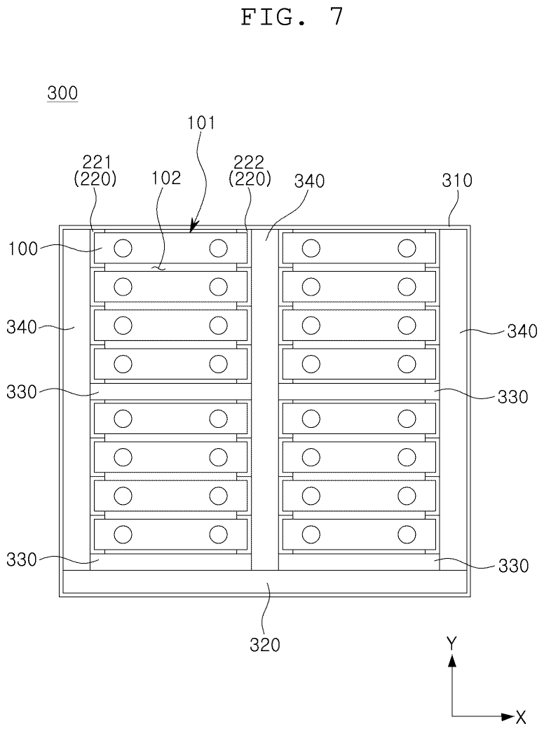

FIG. 7 is a top view of a battery device according to an embodiment.

Referring to FIG. 7, a battery device 300 may include at least one cell assembly 101 and a frame 310. The description of the battery cell 100 and/or the side cover 220 of FIGS. 1 to 6 may be applied to the battery cell 100 and/or the cover 220 of FIG. 7.

According to an embodiment, the battery device 300 may be a battery module, a battery pack, or a power storage system.

The cell assembly 101 may include a plurality of battery cells 100. The plurality of battery cells 100 may be connected using the side cover 220. For example, the plurality of battery cells 100 may be coupled using grooves (e.g., the grooves 240 of FIG. 2) and protrusions (e.g., the protrusions 250 of FIG. 2) formed in the first side cover 221 and the second side cover 222. By coupling the plurality of battery cells 100 using the side cover 220, a heat dissipation space 102 may be formed between cases (e.g., the cases 120 of FIG. 1) of the plurality of battery cells 100. The heat dissipation space 102 may be an empty space formed between side surfaces of the case 120 (e.g., the third side surface 120d and the fourth side surface 120e of FIG. 2). For example, the cases 120 of the plurality of battery cells 100 may be spaced apart based on a width direction (e.g., the Y-axis direction) of the battery cells 100. The arrangement method of the cell assembly 101 illustrated in FIG. 7 is optional. For example, the number of battery cells 100 included in one cell assembly 101 may be optionally changed.

The frame 310 may accommodate at least one cell assembly 101. For example, the frame 310 may include a bottom portion supporting a bottom surface of the cell assembly 101, a cover portion (not shown) covering an upper portion of the cell assembly 101, and a side wall connecting the bottom portion and the cover portion.

According to an embodiment, the battery device 300 may include a battery controller 320 for controlling the battery cell 100. The battery controller 320 may be disposed within the frame 310. The battery controller 320 may include a battery management system (BMS). The configuration of the battery controller 320 is known in various forms, so a detailed description thereof will be omitted. According to an embodiment, the battery controller 320 may be referred to as a processor.

According to an embodiment, the battery device 300 may include a partition 330 located within the frame 310. The partition 330 may be disposed within the frame 310 to reinforce the rigidity of the frame 310. The cell assembly 101 may be located between a plurality of partitions 330.

According to an embodiment, the battery device 300 may include a duct member 340 located within the frame 310. The duct member 340 may include venting holes providing a path for gas and/or flames discharged from the cell assembly 101.

The above-described contents are merely examples adopting the principles of the present disclosure, and other components may be further included without departing from the scope of the present disclosure.

Although the embodiments of the present disclosure have been described above, the scope of the present disclosure is not limited thereto and it will be apparent to those skilled in the art that various modifications and variations may be made within the scope not departing from the technical idea of the present disclosure described in the claims. For example, the present disclosure may be implemented by deleting some of the components in the above-described embodiments, and the respective embodiments may be implemented in combination with each other.

1. A battery cell comprising:
an electrode assembly;
a case accommodating the electrode assembly; and
a cover surrounding at least a portion of the case and including a cooling passage,
wherein the cover includes a first surface, including a groove, and a second surface spaced apart from the first surface and including a protrusion, and
at least a portion of the case is located between the first surface and the second surface.

2. The battery cell of claim 1, wherein the case includes a bottom surface, a first side surface extending from the bottom surface, and a second side surface extending from the bottom surface and spaced apart from the first side surface, and the cover includes a base cover and a side cover connected to the base cover and including a first side cover covering the first side surface and a second side cover covering the second side surface.

3. The battery cell of claim 2, wherein the cooling passage includes an inlet formed in the first side cover, a connection passage formed in the base cover and connected to the inlet, and an outlet formed in the second side cover and connected to the connection passage.

4. The battery cell of claim 2, wherein the side cover includes a first end portion having a first width and facing the base cover and a second end portion, opposite to the first end portion, having a second width less than the first width.

5. The battery cell of claim 4, wherein the second end portion includes a curved portion, and a flow rate of a refrigerant passing through the cooling passage located at the second end portion is faster than a flow rate of a refrigerant passing through the cooling passage located at the first end portion.

6. The battery cell of claim 2, wherein
the case includes a third side surface located between the first side surface and the second side surface and a fourth side surface located between the first side surface and the second side surface and spaced apart from the third side, and
the side cover includes a first extension forming the first side surface and covering at least a portion of the third side surface and a second extension forming the second side surface and covering at least a portion of the fourth side surface.

7. The battery cell of claim 2, wherein the electrode assembly and the case are located between the first side cover and the second side cover.

8. The battery cell of claim 2, further comprising a sealing member disposed on the side cover and surrounding at least a portion of the cooling passage.

9. The battery cell of claim 2, wherein the base cover and the side cover are formed integrally.

10. The battery cell of claim 1, wherein the first surface faces in a first direction, and the second surface faces in a second direction, opposite to the first direction.

11. A battery device comprising:
a plurality of battery cells; and
a frame accommodating the plurality of battery cells,
wherein each of the plurality of battery cells includes:
an electrode assembly;
a case accommodating the electrode assembly; and
a cover surrounding at least a portion of the case and including a cooling passage,
wherein the cover includes a first surface, including a groove, and a second surface spaced apart from the first surface and including a protrusion, and
at least a portion of the case is located between the first surface and the second surface.

12. The battery device of claim 11, wherein the plurality of battery cells are coupled to each other using the cover in which the groove and the protrusion are formed.

13. The battery device of claim 11, wherein the cases of the plurality of battery cells are spaced apart from each other.
